(19) United States
(12) Patent Application Publication
(10) Pub. No.: US 2004/0209585 A1
(43) Pub. Date: Oct. 21, 2004

(54) Method and apparatus for determining an interference level on a fading channel

(75) Inventors: Michael Mao Wang, Hawthorn Woods, IL (US); Tyler A. Brown, Mundelein, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/417,874

(22) Filed: Apr. 17, 2003

(51) Int. Cl. H04B 17/00

(52) U.S. Cl. 455/226.1; 455/296

(57) ABSTRACT

An interference level estimator 205 and corresponding method FIG. 6 can be used in a wireless communications device 200 and is operable to estimate an interference level of interference that is received over a fading channel. The interference level estimator comprises a processor 207 for processing a despread Code Division Multiple Access (CDMA) signal and the interference to remove a portion of the despread CDMA signal and a portion of the interference to provide a residual interference and for determining the estimate of the interference level from the residual interference, where the interference level is fading speed invariant.

### FIELD OF THE INVENTION

This invention relates in general to communication systems, and more specifically to a method and apparatus for determining an interference level on a fading channel for interference at a wireless communications unit

### BACKGROUND OF THE INVENTION

Communications systems are known and over time these systems and constituent equipment have evolved from sensitivity limited designs to interference limited designs, thereby generally enabling more services to more users at reduced costs. As these systems evolve so has the importance of knowing the level of interference that a communications unit is experiencing. Traditionally the interference level is determined as the variance of a received signal plus interference. The received signal can be modeled as a known and constant transmitted signal modified by the channel gain. As long as the channel gain is stable this approach will provide reasonable estimates for the interference level. However when the channel gain is not stable, such as is the case for a fading channel, the known approach for providing an interference estimate can overstate the actual level, thus reducing system capacities. Clearly a need exists for a method and apparatus for determining, at a wireless communications unit, an interference level of interference on a fading channel, where the interference level is essentially independent of fading effects due to the channel.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a diagram of a communications system that will be used to explain an environment for the preferred embodiments in accordance with the present invention;

FIG. 2 depicts, in a simplified and representative form, a block diagram of a wireless communications unit suitable for utilizing an interference level estimator according to the present invention;

FIG. 3 illustrates a more detailed block diagram of a wireless communications receiver that can be used in the FIG. 2 communications unit;

FIG. 4 depicts a more detailed block diagram of an interference level estimator for use in the FIG. 3 communications unit;

FIG. 5 illustrates a further block diagram for one embodiment of portions of the FIG. 4 block diagram;

FIG. 6 is a flow chart of a preferred method embodiment of ascertaining an interference level; and

FIG. 7 shows a plot of experimental data demonstrating the performance of a preferred embodiment of the interference estimator of the present invention.

### DETAILED DESCRIPTION OF PREFERRED EMBODIMENT

In overview, the present disclosure concerns communications systems that provide service to communications units or more specifically user thereof operating therein. More particularly various inventive concepts and principles embodied in methods and apparatus for determining, at a wireless communications unit, an interference level of interference on a fading channel, where the interference level is essentially independent of fading effects due to the channel. The communications systems and equipment of particular interest are those being planned and deployed such as Universal Mobile Telephone Systems (UMTS), other 3^{rd} Generation systems such as Wideband Code Division Multiple Access (WCDMA) systems, CDMA 2000 systems or the like and evolutions thereof that rely on accurate interference level estimates for one or more of network management, call or traffic scheduling, decoding, power control, etc.

As further discussed below various inventive principles and combinations thereof are advantageously employed to essentially eliminate, remove, or avoid effects due to the fading channel on the determination of an interference level thereby providing a more accurate estimate of the interference level. This will alleviate various problems, such as over estimating interference levels, associated with known approaches and facilitate the realization of a communications system's full capacity provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Referring to FIG. 1, a simplified and representative diagram of a communications system will be used to explain an environment for the preferred embodiments. FIG. 1 shows a wireless communications unit 101, such as a cellular handset or subscriber device, messaging device, or other device equipped for wireless operation in a wireless communications system. The wireless communications unit is shown connected or coupled to a radio access network including a wireless infrastructure 103 via a channel depicted as two rays, one a direct ray 105 and the other an indirect ray 107. The indirect ray 107 is reflected from an obstacle, such as a building 109. This channel is often referred to as a fading or faded channel since the different path lengths and thus delays can result in constructive or destructive combination of the signals from the respective rays at the communications unit. As the wireless communications unit 101 travels through the coverage area the number of rays as well as path lengths for each ray will change with the net result being a faded or fading signal due to the changing result of the combination of signals from various rays.

Also depicted is a further radio access network including infrastructure 111 that is transmitting a signal, presumably to other communications units, and this signal via a direct interfering ray 113 and indirect interfering ray 115 represents interference to the wireless communications unit 101. Note that in actual systems the interfering signal may be transmitted from a neighboring cell or coverage area and there may be more than one such interfering or neighboring cell. The relative location of the wireless communication unit between the serving cell or infrastructure 103 and interfering cells, such as infrastructure 111 as well as amount of traffic on or being carried by the interfering cells, channel conditions, etc. will have an effect on the interference level the wireless communications unit 101 is experiencing.

For example, the conventional interference level or variance estimate is based on the standard variance estimate formula:

$${\hat{σ}}^{2} = \frac{1}{N} {\sum }_{n = 1}^{N} {\vert {x}_{n} - \hat{μ} \vert}^{2} , where \hat{μ} = \frac{1}{N} {\sum }_{n = 1}^{N} {x}_{n} and {x}_{n} = {α}_{n} {s}_{n} + {i}_{n} .$$

Her αₙ is the channel gain, sₙ is usually a constant signal, sₙ=s=constant, such as a pilot signal in a CSMA system, etc. It then follows that the expected value of the variance estimate can be stated as:

E{\hat{σ}²}=|s|²σₐ²+σᵢ²

For static or non fading channels, the variance of the channel gain, σₐ²=0 so that,

E{\hat{σ}²}=σᵢ², or the expected value of the variance is equal to the interference level or interference variance. This method or approach is thus appropriate and sufficient for static channels. However, for fading channel, σₐ²≠0, and the standard estimate will include both a fading variance and the interference variance or level:

E{\hat{σ}²}=|s|²σₐ²+σᵢ²>σᵢ²

Note that the interference level or interference is biased or overstated. The amount of the bias depends on the fading signal strength and variance. As further discussed below various methods and apparatus have been developed to insure better or more accurate estimates of this interference level, regardless of fading conditions such as speed or velocity of movement of the wireless communications unit.

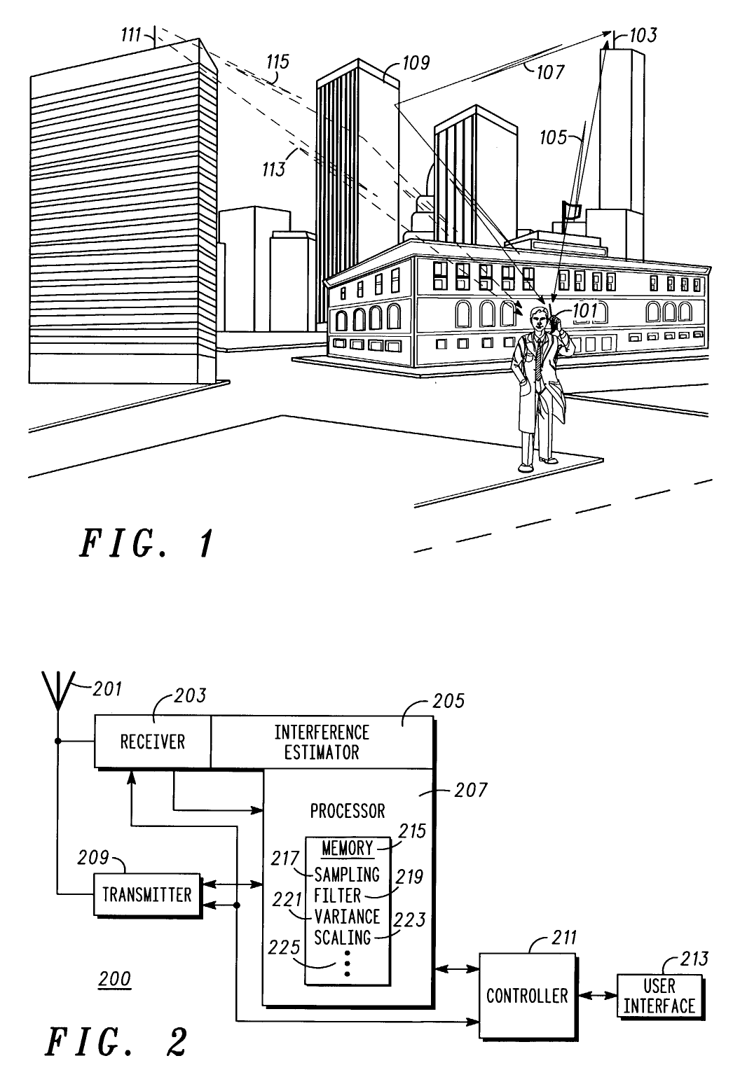

Referring to FIG. 2, a simplified and representative block diagram of a wireless communications unit 200 suitable for utilizing a preferred embodiment of an interference level estimator will be discussed and described. The wireless communications unit 200 is similar to and can be used as the communications unit 101 in FIG. 1. The wireless communications unit includes an antenna 201 that is coupled to a receiver 203. The receiver function is generally known and in this environment as in most wireless environments operates and is operable to receive a signal 105, 107 and interference 113, 115 over the fading channel. The receiver performs various other generally known functions, such as, down conversion, synchronization, analog to digital conversion and various functions that may be air interface technology specific, such as despreading the signal when the air interface technology in CDMA, in order to provide a base band signal including the signal or despread CDMA signal and interference as received. Given that most of the functions are not relevant, only those that are will be further discussed below.

The receiver 203 is coupled to or can include an inventive interference estimator 205 that is operable to ascertain or estimate an interference level of the interference that is received over the fading channel. Advantageously this interference estimator 205 provides an estimate of the interference level that is invariant with fading speed or the speed at which the communications device may be moving. Generally this is accomplished by removing those portions of the signal that may be effected by the fading channel as well as portions of the interference to provide a residual interference, determining a variance or interference level of the residual interference, and scaling or weighting or adjusting the interference level of the residual interference to account for or in accordance with the portion of the interference that has been removed. For the interference estimator 205 to operate properly, apriori knowledge of the characteristics or properties of the interference that has been removed must be available or subject to reasonable estimates.

The interference estimator 205 is coupled to or includes a processor 207 that assists with, facilitates, or performs much of the functionality of the interference estimator as further described below. The processor 207 is a known digital signal processor (DSP) such as one of the 56000 family of DSPs available from Motorola, Inc. of Schaumburg, Ill. This processor or DSP is likely responsible for various duties, such as base band receive and transmit call processing, in addition to the interference estimation functions. The processor 207 is inter coupled to the receiver 203, a transmitter 209, and a general purpose controller 211 for the wireless communications device 200.

The transmitter 209 is generally known and under control of the processor 207 or controller 211, responsible for or used for converting base band signals, including information or data to radio frequency signals and sending or transmitting the radio frequency signals via the antenna 201 on the uplink channel to the infrastructure. For example once the interference estimator has determined an interference level the transmitter as part of various control channel information will send or report the interference level or more generally information corresponding to the interference level to the infrastructure. Such information corresponding to the interference level can include, for example power control information, such as increase or decrease the downlink power level for the signal or can be a channel quality indication or SNR at the mobile (Ec/No=energy per chip/noise power).

The controller 211 is a general purpose controller, such as an HC11 family microprocessor available from Motorola. The controller 211 includes associated memory (not shown) with operating software, data and variables that when executed by the controller controls the wireless communications unit, including the receiver 203, transmitter 209, and processor 207 pursuant to known ends. Additionally the controller 211 is inter coupled to and drives and responds to a user interface 213, comprising known entities such as a keypad, display, audio transducers, and other accessory devices, for example. The functions of the controller are generally known and will not be further dwelled upon herein.

As depicted in FIG. 2, the processor 207 includes or is coupled to a memory 215 that stores a basic operating system, data and variables (not shown) as well as other software routines in object code form that facilitate various functionality of the interference estimator or estimation. Note that depending on the implementation more or less of the functionality may be accomplished with the processor 207 or with dedicated circuitry. Preferably, much of the interference estimation is accomplished with the processor and software routines, including a sampling routine 217, filtering routine 219, variance determination or calculation routine 221, scaling or weighting routine 223, as well as other routines 225 that will depend on the particular technologies involved, design choices, and various other factors, as will be recognized by one of ordinary skill in the field. Generally the sampling and filtering routines are used for processing the signal and the interference as received to remove a portion of the signal and a portion of the interference to provide a residual interference while the variance and scaling routines are used for determining the interference level from the residual interference, where the interference level is fading speed invariant.

Thus in summary we have described a wireless communications device 200 including an interference level estimator 205 for determining and reporting an interference level of interference that is received over a fading channel. The wireless communications device includes the receiver 203 for receiving over the fading channel and, if a CDMA air interface is used, despreading a Code Division Multiple Access (CDMA) signal and interference to provide a despread Code Division Multiple Access (CDMA) signal and interference. Further included is a processor 207 that is coupled to the receiver and operable to or used for processing the despread Code Division Multiple Access (CDMA) signal and interference to remove a portion of the despread CDMA signal and the interference to provide a residual interference and further for determining the interference level from the residual interference. The transmitter 209 is coupled to the processor and used for reporting information corresponding to the interference level.

The interference estimator or processor further comprises or enables a sampler for sampling the despread CDMA signal and the interference at a sampling rate that is higher than expected frequency components of the portion of the despread CDMA signal that results from the fading channel to provide a sampled despread CDMA signal and interference. The processor or interference estimator further preferably includes or facilitates or enables a filter for filtering the sampled despread CDMA signal and interference to reject the expected frequency components. The processor determines the interference level from the residual interference by calculating a variance of the residual interference and scales or weights this variance of the residual interference to correct for effects on or attenuation of the variance resulting from the filter-to provide an accurate estimate of the interference level, thereby providing an accurate estimate of the interference level.

Referring to FIG. 3, a more detailed block diagram of a wireless communications receiver that can be used in the FIG. 2 communications unit will be discussed and described. The simplified diagram of FIG. 3 is suitable for showing where the interference estimator 205 and processor 207 fits within a CDMA receiver and CDMA receive signal processing. As shown the antenna 201 is coupled to the receiver 203 including a despreader 303. The despreader 303 is known and essentially multiplies a base band version of the received signal and interference after conversion to a digital signal by a predetermined pseudo random (PN) sequence or code, referred to as the short code or scrambling code in UMTS systems. The output of the despreader and results of the despreading are coupled to a pilot channel correlator 305 and traffic channel correlator 307. These correlators, respectively, correlate the output results from the despreader with a pilot spreading or walsh sequence and a traffic channel spreading sequence that is wireless communications unit specific (set up at time of call). In 3G systems the base band signal is an I and Q base band signal each comprising 1.2288 Million chips per second in CDMA2000 systems and 3.84 Mchips per second in UMTS systems where each chip is implementation dependent but may be 4-5 bit wide.

The output of the pilot channel correlator 305 at terminal 308 is the signal and the interference as received, preferably, in a discrete form. In this CDMA receiver, this signal has been despread and correlated and will now have characteristics, such as power spectral densities approximating the original signal. On the other hand the interference by virtue of the dispreading and correlation processes will be further spread to a uniform or white noise spectral pattern or density extending from near zero up to base band signal bandwidth frequencies (5 MHz for 3G systems and 1.25 MHz for IS95). The signal and interference, as received, is coupled to the interference estimator 205/207, a channel estimator 309, and the channel quality indicator 317. The interference estimator provides an estimate of the interference level as discussed above or as further discussed below. This interference level at terminal 316 as well as the output 308 from the pilot channel correlator 305 are each coupled to a channel quality indicator 317. The channel quality indicator 317 provides a channel quality estimate at terminal 319 that is a function, such as Ec/No (ratio of energy per chip to noise power, where noise is used to refer to all forms of undesired energy) or ratio of signal power or level to interference power or level.

This channel quality estimate is coupled to the processor 207 and may be used for various purposes, such as whether to request an increase or decrease in downlink power, or to report channel quality, which can be used to determine data rate on downlink channel in some systems.

The channel estimator 309 estimates the conjugate of the complex channel gain. The output signal from the traffic channel correlator 307 is coupled to a multiplier 311 or scaling function where this output signal is weighted by the output of the channel estimator 309. The weighted result is then coupled to a channel decoder 313 which provides channel decoded bits at terminal 315 that are coupled to the processor 207 for further call processing, such as vocoding and the like.

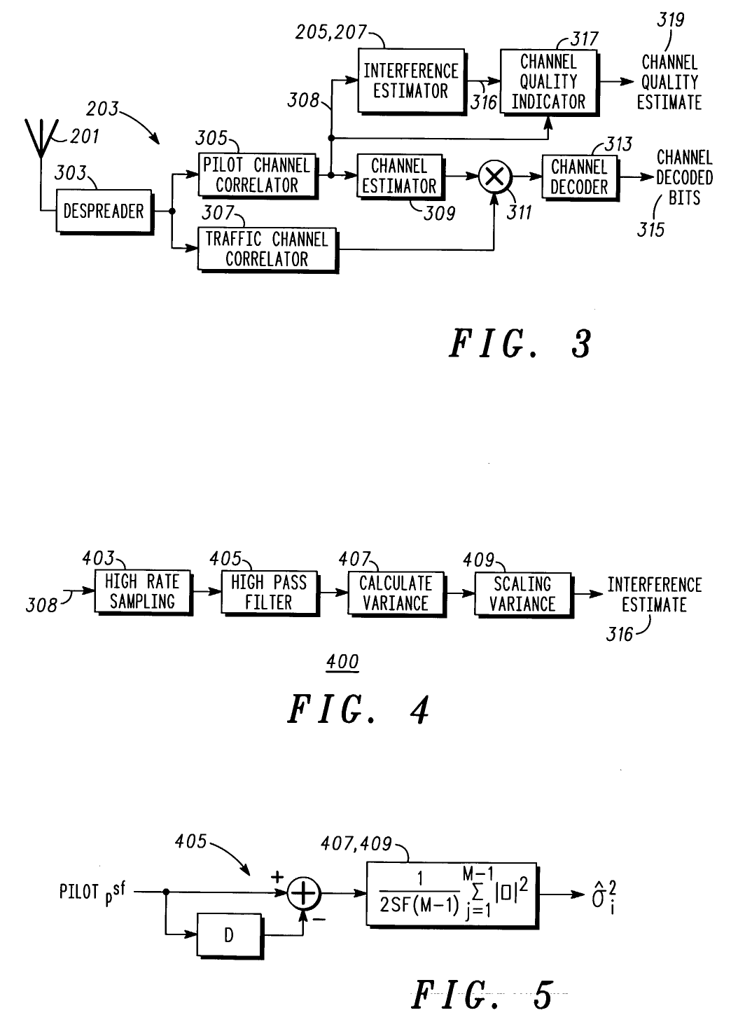

Referring now to FIG. 4, a more detailed block diagram of an interference level estimator for use, for example, in the FIG. 3 communications receiver will be discussed and described. FIG. 4 shows a block diagram of an interference level estimator 400 for use in a wireless communications device to estimate an interference level of or for interference that is received over a fading channel, such as the interference at terminal 308. The interference level estimator 400 may be implemented as a processor, such as a DSP, or as dedicated circuitry, such as a custom or semi custom integrated circuit or a combination of the two with each assisting the other. In any event the interference estimator via the processor or other circuitry processes the despread Code Division Multiple Access (CDMA) signal and the interference to remove a portion of the despread CDMA signal and a portion of the interference to provide a residual interference; and determines the estimate of the interference level from the residual interference in a manner where the interference level is fading speed invariant.

The processor or other circuitry as part of processing the despread CDMA signal and interference includes or implements a sampler 403 for sampling the despread CDMA signal and the interference at a sampling rate that is higher than expected frequency components of the portion of the despread CDMA signal that result from the fading channel to provide a sampled despread CDMA signal and interference. For example in one experimental embodiment the input to the sampler was a sequence of samples at a 1.2288 M samples per second. The sampling rate was set at 19.2 kHz to provide output samples at that rate. The interference level estimator, specifically processor or other circuitry further comprises a filter, preferably a high pass filter 405 coupled to the output of the sampler, for filtering the sampled despread CDMA signal and interference to reject or attenuate the expected frequency components. In order to determine the estimate of the interference level from the residual interference the processor or other circuitry calculates a variance of the residual interference at the variance calculator 407. The output from this calculation block 407 is coupled to a scaling operation where the variance of the residual interference is weighted or adjusted to correct for effects on the variance resulting from the filtering the sampled despread CDMA signal and interference to provide an accurate estimate of the interference level at 316.

Thus to exclude variations due to fading from the estimate of the interference level, the interference estimator removes the portion of the signal that has a spectrum that has been effected by the fading from the total signal plus interference. Using the notation from above the filter filters the sequence xₙ with a high-pass filter such that the signal sαₙ is removed (the channel gain, αₙ, may be viewed as a fading signal with a limited upper frequency range or a low-pass signal). Before filtering the signal plus interference as received is sampled and, preferably, the sampling-rate is selected to be high enough so that a simple high-pass filter can be used to remove most of the fading signal energy. By sampling the signal at a rate much higher than the fading rate, the bandwidth of the interference will be much wider than that of the fading signal, sαₙ, and a high-pass filter, H(z), can be used to remove the fading signal from the received signal as indicated by the equation:

X′(z)=H(z)X(z)

The variance of the residual interference is then estimated as:

$${\hat{σ}}_{{x}^{′}}^{2} = \frac{1}{N} {\sum }_{n = 1}^{N} {\vert {x}_{n}^{′} \vert}^{2}$$

where N is the number of samples in an estimate window (18 samples in a simulation)

Using the observation from above that the interference for example in a CDMA system, is uniform or white (due the PN sequences used for spreading and despreading) the residual interference variance can then, in general, be appropriately weighted or scaled to recover the total interference variance or interference level or estimate thereof using the following equation:

$${\hat{σ}}_{i}^{2} = \frac{{\hat{σ}}_{{x}^{′}}^{2}}{\frac{SF}{π} {\int }_{0}^{π} {\vert H ( {ⅇ}^{j ω} ) \vert}^{2} ⅆ ω} = \frac{1}{\frac{SF \cdot N}{π} {\int }_{0}^{π} {\vert H ( {ⅇ}^{j ω} ) \vert}^{2} ⅆ ω} {\sum }_{n = 1}^{N} {\vert {x}_{n}^{′} \vert}^{2} ,$$

the spreading factor, that was set to 64 for the simulation.

By using a relatively high sampling rate a simple high-pass filter can be used as that will provide sufficient rejection of the signal and the frequency components due to the fading channel and thus reduce or minimize estimation variance with little filter complexity. Of course, by using the equation above a more complex multi pole filter can be used and the proper scaling or weighting factor applied. With a more complex filter the sampling rate can be lowered and useful results obtained. The proper trade off can be found using experimental or simulation results.

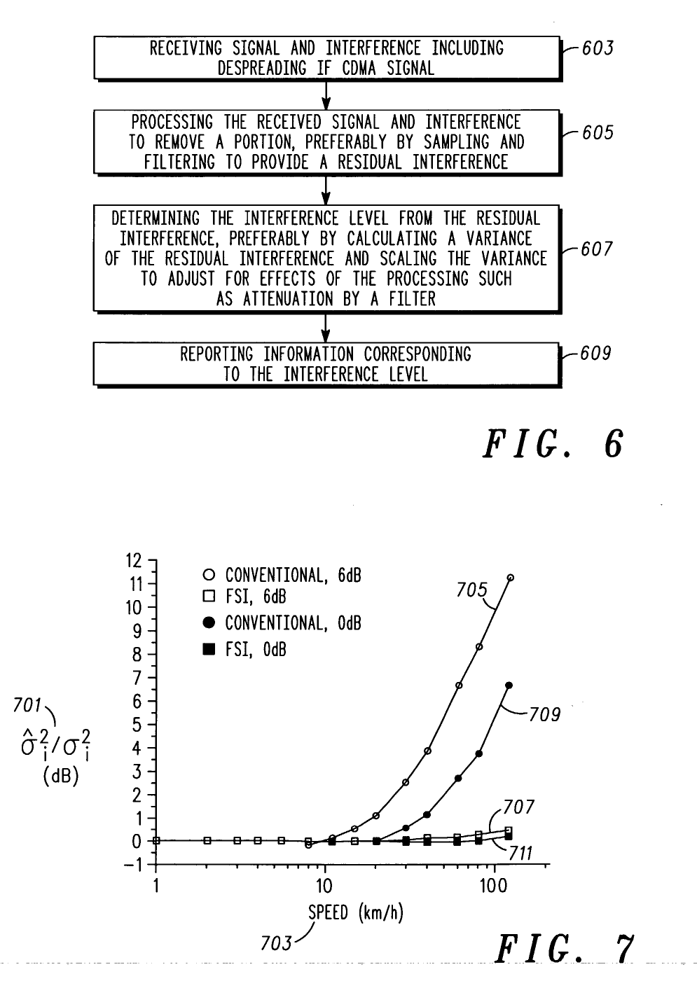

Referring to FIG. 5 a further block diagram for one embodiment of portions of the FIG. 4 interference level estimator will be discussed and described. FIG. 5 depicts one approach where a 19.2 KHz sampling rate was used and a simple single pole filter was utilized. As noted above when the sampling rate of the received signal is high enough, a simple high-pass filter, i.e., a differential filter, can be used to simplify the operation and the equation above becomes:

$$\frac{1}{2 SF ( M - 1 )} {\sum }_{j = 1}^{M - 1} {\vert {p}_{l}^{SF} ( j ) - {p}_{l}^{SF} ( j - 1 ) \vert}^{2} ,$$

since the total variance recovery factor is

$$\frac{1}{π} {\int }_{0}^{π} {\vert H ( {ⅇ}^{j ω} ) \vert}^{2} ⅆ ω = 2$$

which can be implemented by a simple shift operation.

In FIG. 5, the output of the sampler, such as sampler 403 in FIG. 4 is shown as a pilot signal or a predetermined signal, with the effects of fading, is coupled to the input of a simple filter 405. The pilot signal is used on a control channel in most CDMA systems and allows a wireless communications unit to synchronize to the serving cell. The spreading factor is known in CDMA systems and can be viewed as the length of the correlation performed by the pilot channel correlator 305. The output of the filter goes to the variance and scaling block 407, 409 where the variance of the output of the filter is calculated and then scaled. Specifically the sum over j of the square of the difference between a current sample and a past sample is calculated and then scaled by 1/2SF(M-1) to provide the interference level at output 316. It is noted that this implementation is more straightforward than the traditional variance calculation as there is no need to calculate the mean of the pilot or other signal.

It is also noted that it is not necessary for the interference to be white as was the situation for the above equations. All that is required is that the interference or noise spectrum be known so that the effect of filtering, such as high-pass can be accounted for in the final determination of the interference level. Putting it another way, if the spectrum of the interference is σᵢ²S(f) and the high-pass filter has transfer function H(f), then the filtered interference spectrum can be described as σᵢ²|H(f)|²S(f). The variance or power of the filtered interference is then obtained by integrating, i.e., σᵢ²∫_{-∞}^{∞}S(f)|H(f)|²df. The result is proportional to σᵢ² which is the quantity we would like to estimate except for the proportionality constant ∫_{-∞}^{∞}S(f)|H(f)|²df. In order to calculate this proportionality constant we need to know S(f). In the case of white noise, S(f) is uniform and this calculation is trivial.

Referring to FIG. 6 a flow chart of a preferred method embodiment of ascertaining an interference level will be discussed and described. Much of this discussion will be a review of the concepts and principles discussed above. The method depicted in FIG. 6 may be implemented with the structure noted above or other appropriate structures. Generally the method of FIG. 6 is intended to be performed in a communications receiver and is a method for ascertaining an interference level of interference that is received over a fading channel. The method comprises receiving a signal and the interference over the fading channel further including despreading the signal, etc. if the channel or signal is a CDMA signal 603.

Then at 605 processing the signal and the interference as received to remove a portion of the signal and a portion of the interference to provide a residual interference is performed. This is preferably accomplished with a sampling and filtering operation. Specifically the sampling operation includes sampling the signal and the interference as received at a sampling rate that is higher, by at least a factor of 2 per Nyquist's criteria and preferably 4 or more than the expected frequency components of the portion of the signal that result from the fading channel to provide a sampled signal and interference. Then filtering includes filtering the sampled signal and interference with a filter that rejects the expected frequency components.

Next at 607 determining the interference level from the residual interference, is performed where the interference level as determined is fading speed invariant. Preferably determining the interference level from the residual interference further comprises calculating a variance of the residual interference and scaling or adjusting the variance of the residual interference to correct for effects, such as attenuation, on the variance resulting from the filtering the sampled signal and interference to provide an accurate estimate of the interference level. Then 609 depicts reporting information corresponding to the interference level to for example the infrastructure and the like.

Referring to FIG. 7 a plot of experimental data obtained from simulation results demonstrating the performance of a preferred embodiment of the interference estimator will be discussed and described. The data in FIG. 7 was obtained from a simulation of CDMA2000 with a sampling rate of 19.2 KHz (SF=64). FIG. 7 shows the ratio of the estimated interference level divided by the actual interference level in dB on the vertical axis 701 and the speed or velocity of the unit that gives rise to the fading according to known relationships is shown on the horizontal axis 703. Of course the desired performance is a line at 0 dB as it is preferred that the estimate closely approximate the actual interference. The performance of the conventional interference estimator when the estimator is located near the serving cell signal source is shown by curve 705 and this curve departs the desired curve for speeds above approximately 10 kilometers per hour. The performance of an embodiment in accordance with the invention as shown by curve 707 advantageously approximates the ideal performance curve at speeds up to 100 kilometers per hour. Similarly for an estimator located near the edge of the serving cell, the curve 709 shows a departure from the desired performance at approximately 20 kilometers per hour. Again the embodiment performs well at speeds over 100 kilometers per hour as shown by curve 711.

The processes, apparatus, and systems, discussed above, and the inventive principles and concepts thereof can alleviate problems caused by prior art interference level estimators. Using these principles of separating a portion of the interference and signal that will result in an estimate that varies with fading speed from the interference that will not vary and then adjusting the estimate of the interference level to account for the part that has been removed will facilitate accurate interference estimates. Using the inventive principles and concepts disclosed herein advantageously allows or provides for accurate interference estimates and thus allows systems to operate closer to design capacities thus providing more services to more users and this will be beneficial to users and providers a like.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method in a communications receiver for ascertaining an interference level of interference that is received over a fading channel, the method comprising:
receiving a signal and the interference over the fading channel;
processing the signal and the interference as received to remove a portion of the signal and a portion of the interference to provide a residual interference; and
determining the interference level from the residual interference, the interference level being fading speed invariant.

2. The method of claim 1 wherein the processing the signal and the interference as received further comprises sampling the signal and the interference as received at a sampling rate that is higher than expected frequency components of the portion of the signal that result from the fading channel to provide a sampled signal and interference.

3. The method of claim 2 wherein the processing the signal and the interference as received further comprises filtering the sampled signal and interference with a filter that rejects the expected frequency components.

4. The method of claim 3 wherein the determining the interference level from the residual interference further comprises calculating a variance of the residual interference.

5. The method of claim 4 wherein the determining the interference level from the residual interference further comprises scaling the variance of the residual interference to correct for effects on the variance resulting from the filtering the sampled signal and interference to provide an accurate estimate of the interference level.

6. The method of claim 1 wherein the determining the interference level from the residual interference further comprises calculating a variance of the residual interference.

7. The method of claim 6 wherein the determining the interference level from the residual interference further comprises scaling the variance of the residual interference to correct for effects on the variance due to the processing the signal and the interference as received to provide an accurate estimate of the interference level.

8. The method of claim 7 wherein the scaling the variance of the residual interference further comprises adjusting the variance to account for attenuation of a high pass filter.

9. The method of claim 1 wherein the receiving the signal and the interference further comprises despreading a Code Division Multiple Access signal to provide the signal.

10. An interference level estimator for use in a wireless communications device to estimate an interference level of interference that is received over a fading channel, the interference level estimator comprising:
a processor for processing a despread Code Division Multiple Access (CDMA) signal and the interference to remove a portion of the despread CDMA signal and a portion of the interference to provide a residual interference; and
determining the estimate of the interference level from the residual interference, the interference level being fading speed invariant.

11. The interference level estimator of claim 10 wherein the processor for processing the despread CDMA signal and the interference further comprises a sampler for sampling the despread CDMA signal and the interference at a sampling rate that is higher than expected frequency components of the portion of the despread CDMA signal that result from the fading channel to provide a sampled despread CDMA signal and interference.

12. The interference level estimator of claim 11 wherein the processor for processing the despread CDMA signal and the interference further comprises a filter for filtering the sampled despread CDMA signal and interference to reject the expected frequency components.

13. The interference level estimator of claim 12 wherein the processor for determining the estimate of the interference level from the residual interference further calculates a variance of the residual interference.

14. The interference level estimator of claim 13 wherein the processor for determining the estimate of the interference level from the residual interference further scales the variance of the residual interference to correct for effects on the variance resulting from the filtering the sampled despread CDMA signal and interference to provide an accurate estimate of the interference level.

15. The interference level estimator of claim 10 wherein the processor for determining the estimate of the interference level from the residual interference further calculates a variance of the residual interference.

16. The interference level estimator of claim 15 wherein the processor for determining the estimate of the interference level from the residual interference further comprises a high pass filter for attenuating the portion of the despread CDMA signal and the interference and the processor scales the variance of the residual interference to correct for attenuation of the variance due to the high pass filter, thereby providing an accurate estimate of the interference level.

17. A wireless communications device including an interference level estimator for reporting an interference level of interference that is received over a fading channel, the wireless communications device comprising:
a receiver for receiving over the fading channel and despreading a Code Division Multiple Access (CDMA) signal and interference to provide a despread Code Division Multiple Access (CDMA) signal and interference;
a processor, coupled to the receiver, for processing the despread Code Division Multiple Access (CDMA) signal and interference to remove a portion of the despread CDMA signal and a portion of the interference to provide a residual interference and further for determining the interference level from the residual interference; and
a transmitter, coupled to the processor, for reporting information corresponding to the interference level, the interference level being fading speed invariant.

18. The wireless communications device of claim 17 wherein the processor for processing the despread CDMA signal and the interference further comprises a sampler for sampling the despread CDMA signal and the interference at a sampling rate that is higher than expected frequency components of the portion of the despread CDMA signal that result from the fading channel to provide a sampled despread CDMA signal and interference.

19. The wireless communications device of claim 18 wherein the processor for processing the despread CDMA signal and the interference further comprises a filter for filtering the sampled despread CDMA signal and interference to reject the expected frequency components.

20. The wireless communications device of claim 19 wherein the processor for determining the interference level from the residual interference further calculates a variance of the residual interference.

21. The wireless communications device of claim 20 wherein the processor for determining the interference level from the residual interference further weights the variance of the residual interference to correct for effects on the variance resulting from the filter to provide an accurate estimate of the interference level.

22. The wireless communications device of claim 17 wherein the processor for determining the interference level from the residual interference further calculates a variance of the residual interference.

23. The wireless communications device of claim 22 further including a high pass filter to attenuate the portion of the despread CDMA signal and the interference and wherein the processor further scales the variance of the residual interference to correct for attenuation of the variance due to the high pass filter, thereby providing an accurate estimate of the interference level.
